(19) United States
(12) Patent Application Publication
(10) Pub. No.: US 2025/0166432 A1
(43) Pub. Date: May 22, 2025

(54) INFORMATION PROCESSING DEVICE

(71) Applicant: TOYOTA JIDOSHA KABUSHIKI KAISHA, Toyota-shi (JP)

(72) Inventors: Kazuya OKADA, Tokyo (JP); Hiroshi ABE, Kasukabe-shi (JP); Naoya KANEKO, Tokyo (JP); Toru FURUSAWA, Yokohama-shi (JP); Takayuki SAKAI, Tokyo (JP); Koji TAKEOKA, Yokohama-shi (JP)

(73) Assignee: TOYOTA JIDOSHA KABUSHIKI KAISHA, Toyota-shi (JP)

(21) Appl. No.: 18/936,284

(22) Filed: Nov. 4, 2024

(30) Foreign Application Priority Data
Nov. 16, 2023 (JP) 2023-195437

(51) Int. Cl. G07C 5/08; G06F 3/06; G07C 5/00

(52) U.S. Cl. CPC G07C 5/085; G06F 3/0604; G07C 5/008

(57) ABSTRACT

The information processing device includes a control unit configured to execute: storing, in a storage unit, an information index related to log data collected by the vehicle and a storage destination of log data associated with the information index; extracting, based on the information index, a first storage that is a storage destination of the first log data that is the log data to be acquired; and requesting the first log data from a device having the first storage, wherein the information index includes information indicating a position at which the log data was collected, and information indicating a position at which the log data was collected is represented by a bit string based on a space-filling curve.

### CROSS-REFERENCE TO RELATED APPLICATION

This application claims priority to Japanese Patent Application No. 2023-195437 filed on Nov. 16, 2023, incorporated herein by reference in its entirety.

### BACKGROUND

### 1. Technical Field

The present disclosure relates to devices that acquire a data log.

### 2. Description of Related Art

A technique is known in which various types of data such as a data log indicating communication quality are sent from a vehicle to a cloud server and stored in a storage on the cloud server. In this regard, for example, WO2019/220630 discloses an information collection device. This information collection device generates a link that associates acquired data and stored data with each other based on the degree of similarity between them, and a link that associates stored data generated when the stored data is read, estimates a future request for the stored data, and determines a storage period of the stored data for each link.

### SUMMARY

It is an object of the present disclosure to reduce the storage capacity and cost required when responding to a data acquisition request.

An aspect of an embodiment of the present disclosure is an information processing device.

The information processing device includes a control unit configured to: store, in a storage unit, an information index related to log data collected by a vehicle and a storage destination of the log data associated with the information index; refer to the storage unit to extract a first storage based on the information index, the first storage being a storage destination of first log data that is the log data to be acquired; and request the first log data to a device including the first storage. The information index includes information indicating a position where the log data was collected. The information indicating the position where the log data was collected is represented by a bit string based on a space-filling curve.

Other aspects include a method that is executed by the above device, a program that causes a computer to execute the method, and a computer-readable storage medium storing the program in a non-transitory manner.

The present disclosure can reduce the storage capacity and cost required when responding to a data acquisition request.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of processing executed by a server device according to an embodiment;

FIG. 2 is a diagram illustrating components of a system including a server device according to an embodiment;

FIG. 3A is a flowchart of a series of processes for acquiring information indexes and the like among processes executed by a control unit of a server device according to an embodiment;

FIG. 3B is a flowchart of a series of processes for identifying a storage destination of log data to be acquired and acquiring the log data, among processes executed by a control unit of a server device according to an embodiment;

FIG. 4A is a block diagram illustrating an example of a space-filling curve-based position information-based code-representation;

FIG. 4B is a block diagram illustrating an example of a space-filling curve-based position information-based code-representation;

FIG. 5 illustrates an arbitrarily shaped region designation in a code representation based on a space-filling curve; and

FIG. 6 is a flowchart of processing for identifying first log data executed by a control unit of the server device according to the embodiment.

### DETAILED DESCRIPTION OF EMBODIMENTS

### Overview

It is assumed that various data such as a data log indicating communication quality is acquired from a vehicle that is a mobile communication terminal, and the data is analyzed and used in various services. In such a system, various types of data are transmitted from a vehicle to a cloud server of the system and stored. However, with such a configuration, a large amount of storage is required for storing the data, and an enormous cost is required. Therefore, the system preferably stores not the data itself but only an index or the like for referring to the data. In addition, it is desirable for the system to acquire the data itself from a storage device installed in or near a vehicle or a vehicle, as required, each time.

A system according to one aspect of the present disclosure includes a control unit for executing:
storing the information index related to the log data collected by the vehicle and the storage destination of the log data associated with the information index in the storage unit,
referring to the storage unit, based on the information index, extracting a first storage which is a storage destination of the first log data is the log data to be acquired, and requesting the first log data to the device having the first storage.
   The information index includes information indicating a position at which the log data is collected, and
   the information indicating the position at which the log data is collected is represented by a bit string based on a space-filling curve.

The log data is, for example, data indicating the communication quality when the vehicle communicates with the base station. The log data is not limited to data indicating communication quality, and may be various data obtained as a result of processing performed by some system including a vehicle or a vehicle.

The information index is information related to log data collected by the vehicle. The information index is various parameters used to identify the log data. For example, the information index may include a date and time at which the log data is collected, information indicating a position at which the log data is collected (including position information, for example, latitude and longitude information, and the like), a vehicle identifier of a vehicle in which the log data is collected, and the like.

It should be noted that the “position” in the present disclosure is a concept including a point and a region of any shape. The point may include predetermined uncertainty, and the uncertainty may be, for example, a circle, an ellipse, or a rectangle. An example of a region of an arbitrary shape may be a polygon (including any quadrangle such as a rectangle, a parallelogram, and a trapezoid, and a polygon of a triangle or a pentagon or more), a circle, an ellipse, and a combination of at least a part thereof. In the present disclosure, at least one of the information representing the position and the information related to the position corresponds to “position information”.

Further, the position information may represent a region, and may have a number of bits corresponding to the size of the region. Typically, the position information is represented by a shorter number of bits as the region is wider (i.e., the granularity is coarser), and the position information is represented by a longer number of bits as the region is narrower (i.e., the granularity is finer).

The position information may be represented by a bit string in which a first bit string specifying the first direction and a second bit string specifying the second direction are alternately arranged by a predetermined number of bits (for example, one bit). Here, the first direction and the second direction are different directions, and the first direction and the second direction are orthogonal to each other as an example. For example, the first direction may be a latitude direction and the second direction may be a longitude direction.

The storage unit is a storage device included in the information processing device according to the present disclosure. The storage unit includes a memory. The storage unit stores an information index acquired from the vehicle and information indicating a storage destination of the log data.

The first storage is a storage device located outside the information processing device according to the present disclosure. The first storage is typically a storage device provided in the vehicle. Alternatively, the first storage may be a server device installed in or near the vehicle. The first storage stores log data collected by the vehicle.

The first log data is log data to be acquired from the first storage by the control unit. The first log data may be specified based on an acquisition request from an external device.

A space-filling curve is a curve that includes the entire unit square, the range of values being two-dimensional.

As a result, the information processing device according to the present disclosure can store only the information index and acquire the log data itself to be acquired by referring to an external storage device each time. Therefore, the information processing device according to the present disclosure can reduce storage capacity and cost required when responding to a data acquisition request.

The information indicating the position at which the log data is collected may be represented by a bit string based on a Hilbert curve or a Z-order curve.

The space-filling curve can be, for example, a Hilbert curve or a Z-order curve. Therefore, the position information included in the information index may be represented by a bit string based on a Hilbert curve or a Z-order curve.

As a result, the information processing device according to the present disclosure can quickly determine the inclusion relationship between the position indicated by the information included in the information index and the position for specifying the first log data by adopting the expression based on the space-filling curve.

Further, the control unit may
receive from an external device an acquisition request for requesting acquisition of the first log data that conforms to a predetermined condition including designation of a predetermined region,
compare a bit string based on a space-filling curve representing the predetermined region with a bit string of information indicated by the position included in the information index, acquire as the first log data, from the first storage, when the position is within the predetermined region, the log data corresponding to the information index including the information indicated by the position, and
transmit the acquired first log data to the external device.

Accordingly, the information processing device according to the present disclosure can quickly identify the first log data requested to be acquired from the external device and efficiently acquire the first log data from the first storage. Therefore, the information processing device according to the present disclosure can reduce the cost of searching for the first log data. That is, the information processing device according to the present disclosure can efficiently execute processing of acquiring the first log data and transmitting the first log data to the external device.

Further, the information index may further include, as a parameter included in a condition for designating the first log data, at least one of a traveling speed of the vehicle, information indicating whether or not a vehicle safety event that is an event related to a traveling state of the vehicle has occurred, and a log level indicating a level of importance of the content represented by the log data.

Accordingly, the information processing device according to the present disclosure can provide the external device with the log data specified by various cuts.

Further, the control unit may

cause the storage unit to store a vehicle identification number (VIN), which is a parameter included in a criterion for designating the first log data, as information indicating a storage destination of the log data.

Thus, the information processing device according to the present disclosure can identify the vehicle that is the storage destination of the first log data.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### Overview of Processing of Server Device

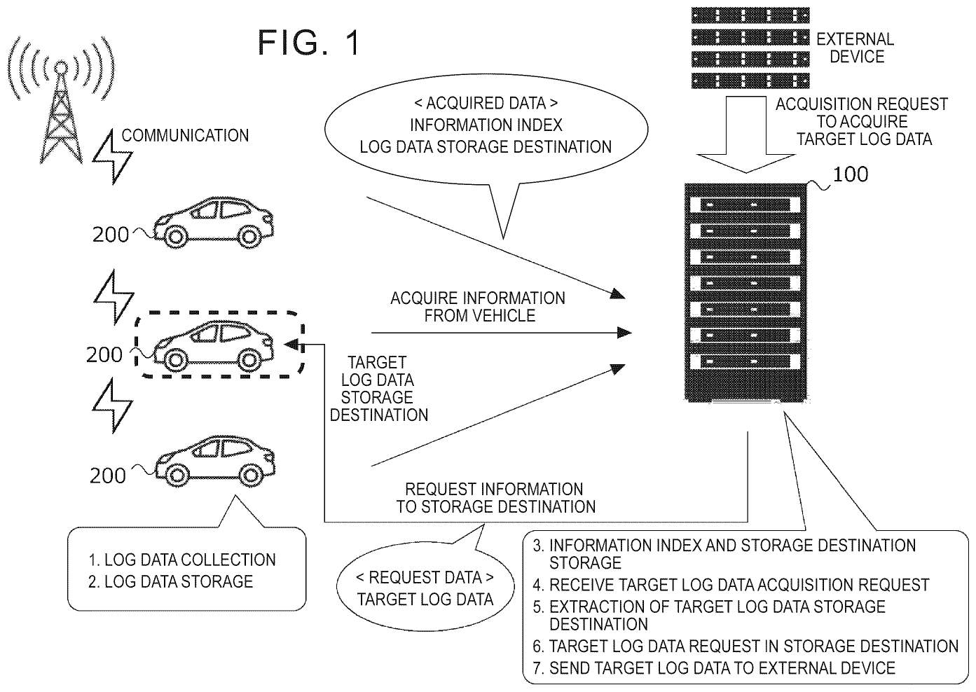

An outline of a process performed by the server device according to the embodiment will be described with reference to FIG. 1. FIG. 1 shows an outline of a process executed by the server device 100 according to the embodiment. Here, the server device 100 is an example of an information processing device according to the present disclosure. The server device 100 performs wireless communication with a plurality of vehicles 200. The plurality of vehicles 200 are mobile communication terminals having a communication function, and perform steady communication with various communication devices or other vehicles via a base station or directly.

First, the plurality of vehicles 200 collect log data indicating the communication quality of the communication performed by the respective vehicles 200. Then, the plurality of vehicles 200 store the collected log data in a storage unit mounted on each vehicle 200. Alternatively, the plurality of vehicles 200 store the collected log data in a storage device such as a server device installed in or in the vicinity of each vehicle 200.

Next, the server device 100 communicates with each of the plurality of vehicles 200, acquires the information index of the log data collected by each vehicle 200 and the information indicating the storage destination of the log data associated with the information index, and records the information in the storage unit of the server device 100. The information index is information including various parameters for specifying log data. For example, the information index includes information about the date and time when the corresponding log data was collected, information about the location where the corresponding log data was collected (e.g., latitude and longitude information), a vehicle identifier of the vehicle 200 that collected the corresponding log data, and the like. That is, the server device 100 records only the information index having a smaller data amount than the log data itself and the information indicating the storage destination of the corresponding log data in the storage unit, instead of the log data itself.

Next, the server device 100 receives an acquisition request, which is information requesting to acquire specific log data (hereinafter referred to as target log data), from an external device. The external device specifies the target log data by using at least one of the parameters included in the information index, and instructs the server device 100 to acquire the target log data.

Subsequently, the server device 100 collates the parameter for specifying the target log data with each parameter included in the information index recorded in the storage unit. Then, the storage destination of the target log data is specified by extracting the storage destination of the log data associated with the information index including the parameter matching the parameter for specifying the target log data. That is, the server device 100 specifies the log data corresponding to the target log data from the information index, and also specifies the storage destination of the log data associated with the information index. Specifically, the server device 100 specifies, as a storage destination of the log data associated with the information index, a vehicle 200 storing the target log data, a storage device installed in or near the vehicle 200, or the like.

Then, the server device 100 requests and acquires the target log data from the storage destination of the specified target log data. Specifically, the server device 100 requests the vehicle 200 storing the target log data to transmit the target log data to the server device 100 and acquires the target log data. When the target log data is stored in a storage device installed in or near the vehicle 200 instead of the vehicle 200, the server device 100 requests the storage device to transmit the target log data to the server device 100 and acquires the target log data.

Finally, the server device 100 transmits the acquired target log data to the external device.

As described above, the server device 100 records only the information index in the storage unit instead of the log data itself, and acquires the log data to be acquired by referring to the external storage device each time. As a result, the server device 100 can respond to the log data acquisition request with a smaller storage capacity than in the case where the log data itself is directly recorded in the storage unit.

According to such a configuration, the information processing device according to the present disclosure can reduce storage capacity and cost required when responding to a data acquisition request.

### Server Device and Vehicle Configuration

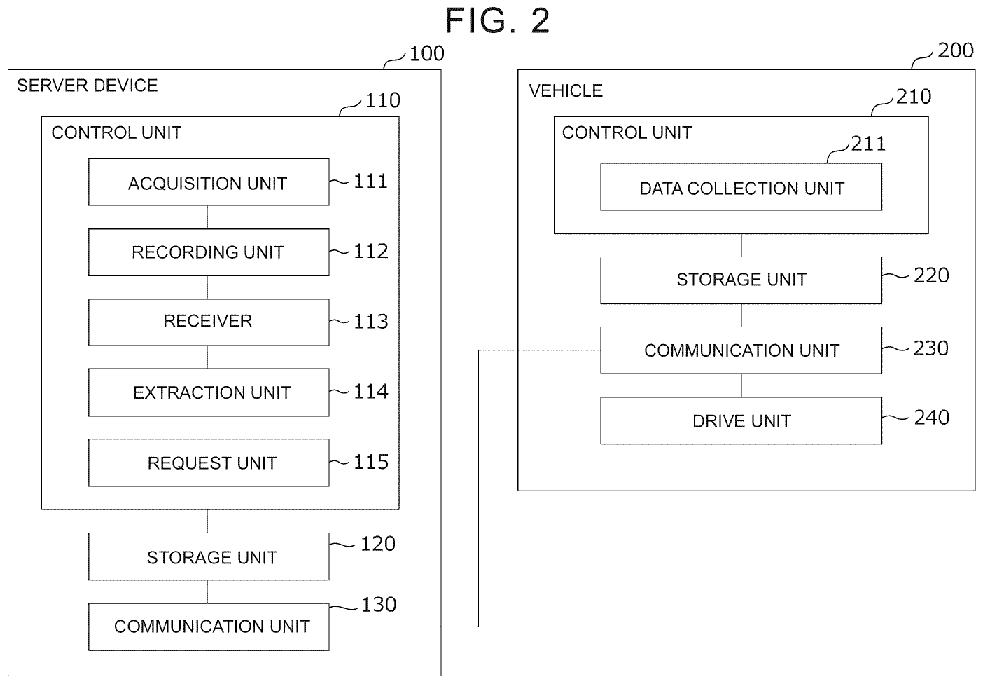

FIG. 2 is a diagram for describing components included in the server device 100 according to the embodiment. In FIG. 2, the server device 100 may be a collection (cloud) of one or more computers.

The server device 100 according to the present embodiment includes a control unit 110, a storage unit 120, and a communication unit 130.

The control unit 110 is implemented by a processor such as a central processing unit (CPU) or a graphics processing unit (GPU) and a memory. The control unit 110 includes, as functional modules, an acquisition unit 111, a recording unit 112, a reception unit 113, an extraction unit 114, and a request unit 115. These functional modules may be realized by executing a program by the control unit 110.

The acquisition unit 111 acquires, from the vehicle 200, an information index related to the log data collected by the vehicle 200 and information indicating a storage destination of the log data associated with the information index. The acquisition unit 111 communicates with the communication unit 230 of the vehicle 200 via the communication unit 130 to acquire the data.

The recording unit 112 records the information index acquired by the acquisition unit 111 and the information indicating the storage destination of the log data in the storage unit 120. The recording unit 112 records the information index and the information indicating the storage destination of the log data corresponding to the information index in the storage unit 120 in association with each other. Further, the recording unit 112 converts information (position information) related to the position at which the log data included in the information index is collected from a format represented by latitude and longitude information or the like into a position code format, and records the converted information in the storage unit 120. For example, the recording unit 112 may convert the position information of the point at which the log data included in the information index is collected into a bit string using a space-filling curve (for example, a Hilbert curve or the like).

The reception unit 113 receives an acquisition request to acquire the first log data from an external device. Here, the first log data is log data to be acquired from a storage device or the like installed in or near the vehicle 200 or the vehicle 200 designated by an external device. The first log data acquisition request may include designation of a predetermined region in which the first log data is collected as a condition for designating the first log data.

The extraction unit 114 refers to the storage unit 120 and extracts the first storage that is the storage destination of the first log data, based on the parameters included in the recorded information index and the parameters for specifying the first log data included in the acquisition request. The extraction unit 114 performs the above-described processing based on the acquisition request of the first log data received by the reception unit 113. The extraction unit 114 extracts the first storage from the plurality of storage destinations included in the information indicating the storage destinations of the plurality of log data.

When the first log data acquisition request includes the designation of the predetermined region in which the first log data is collected, the extraction unit 114 may compare the bit string based on the space-filling curve representing the predetermined region with the bit string of the position included in the plurality of information indexes stored in the storage unit 120. When the position included in the information index is within a predetermined region as a result of the comparison, the extraction unit 114 determines the log data corresponding to the information index including the position as the first log data. Then, the extraction unit 114 may extract the storage destination of the log data associated with the information index including the position as the first storage.

The request unit 115 requests and acquires the first log data from the device having the first storage extracted by the extraction unit 114. For example, when the first storage is the storage unit 220 included in the vehicle 200, the request unit 115 transmits information requesting the vehicle 200 to transmit the first log data to the server device 100, and acquires the first log data. Further, for example, in a case where the first storage is a storage device installed in or near the vehicle 200, information requesting the storage device to transmit the first log data to the server device 100 is transmitted, and the first log data is acquired.

Further, the request unit 115 transmits the acquired first log data to the external device that has transmitted the acquisition request for the first log data to the server device 100. The request unit 115 communicates with an external device via the communication unit 130 and transmits the first log data.

The storage unit 120 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 110. However, some or all of the functions may be implemented by a hardware circuit such as an ASIC or an FPGA.

The storage unit 120 stores data or the like used or generated in processing performed by the control unit 110. Further, the storage unit 120 stores information indicating an information index and a storage destination of the log data received from the vehicle 200 or the like.

The communication unit 130 includes a communication circuit that performs wireless communication. The communication unit 130 may be, for example, a communication circuit that performs wireless communication using 4th Generation (4G) or a communication circuit that performs wireless communication using 5th Generation (5G). The communication unit 130 may be a communication circuit that performs radio communication using long term evolution (LTE) or a communication circuit that performs communication using low power wide area (LPWA). Further, the communication unit 130 may be a communication circuit that performs radio communication using Wi-Fi (registered trademark).

Next, the vehicle 200 communicating with the server device 100 will be described.

The vehicle 200 is a vehicle such as a passenger car. The vehicle 200 may be a truck, a bus, or the like. The vehicle 200 includes a control unit 210, a storage unit 220, a communication unit 230, and a drive unit 240. Vehicle 200 periodically communicates with a base station or other vehicle or comb communication device. In addition, the vehicle 200 periodically transmits information indicating the information index and the storage destination of the log data to the server device 100, and in a case where a request is received from the server device 100, transmits the log data stored therein.

The control unit 210 controls an electronic control unit (ECU) or the like mounted on the vehicles 200. The control unit 210 is implemented by a processor such as a CPU or a GPU and memories. The control unit 210 includes a data collection unit 211 as a software module. The control unit 210 may control the storage unit 220, the communication unit 230, and the drive unit 240 by executing a program.

The data collection unit 211 collects log data representing the quality of communication performed by the vehicle 200. The data collection unit 211 includes information such as a collected date and time, a collected position (for example, represented by latitude and longitude information), and a vehicle identifier of the vehicle 200 for each of the collected log data.

The storage unit 220 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 210. However, some or all of the functions may be implemented by a hardware circuit such as an ASIC or an FPGA.

The storage unit 220 stores data or the like used or generated in processing performed by the control unit 210. The storage unit 220 may store log data.

The communication unit 230 includes a communication circuit that performs wireless communication. The communication unit 230 may be, for example, a communication circuit that performs wireless communication using a 4G or a communication circuit that performs wireless communication using a 5G. The communication unit 230 may be a communication circuit that performs radio communication using a LTE, or may be a communication circuit that performs communication using a LPWA. Further, the communication unit 230 may be a communication circuit that performs radio communication using Wi-Fi (registered trademark).

The drive unit 240 is a means for causing the vehicle 200 to travel. The drive unit 240 may include, for example, a motor, an inverter, a brake, and a steering mechanism for driving wheels. The drive unit 240 may be operated by electric power supplied from a battery.

### Operation of Server Device

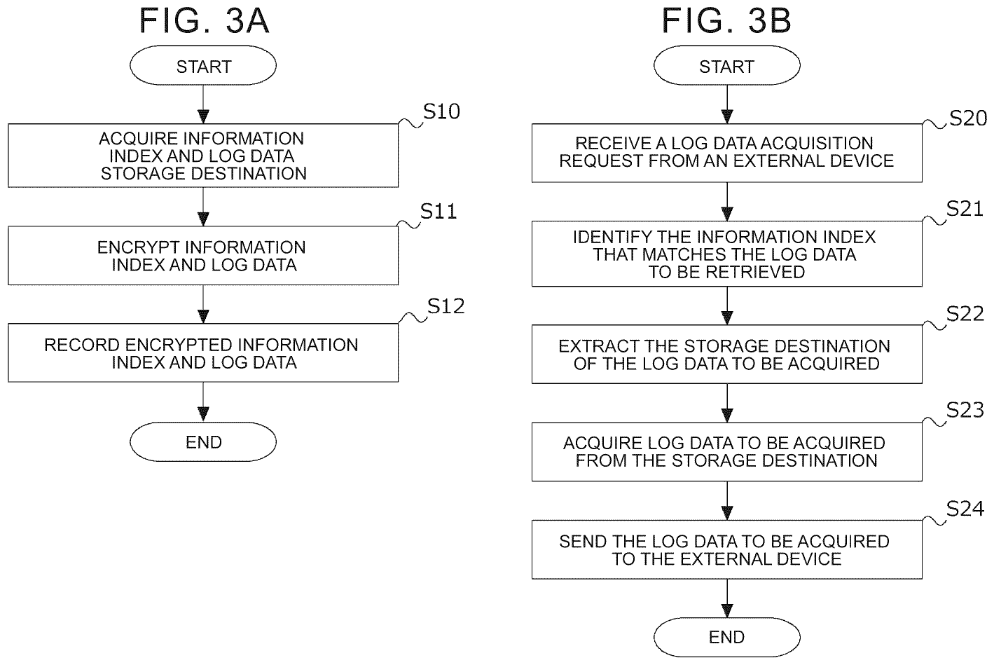

Next, specific contents of the processing performed by the server device 100 will be described. FIGS. 3A and 3B are flowcharts of processes executed by the control unit 110 of the server device 100 according to the embodiment.

First, a process of acquiring an information index and the like performed by the server device 100 will be described. FIG. 3A illustrates a series of processes for acquiring information indexes and the like among the processes performed by the server device 100.

First, in S10, the acquisition unit 111 acquires information indicating the information indexes and the storage destinations of the log data from the plurality of vehicles 200. The information indicating the storage destination of the log data is associated with an information index corresponding to the log data. The acquisition unit 111 communicates with the communication unit 230 of the vehicle 200 via the communication unit 130 to acquire the data.

The information index may include at least one of a traveling speed of the vehicle 200, information indicating whether or not a vehicle safety event that is an event related to a traveling state of the vehicle 200 has occurred, a vehicle identification number (VIN), and a log level indicating a level of importance of content represented by the log data. These are parameters included in the condition for specifying the first log data. Here, the vehicle safety event may be an event such as a sudden acceleration or a sudden stop, for example. Whether or not a vehicle safety event has occurred is detected by various sensors such as an acceleration sensor or a gravity sensor mounted on the vehicle 200.

The information indicating the storage destination of the log data may include a vehicle identification number (VIN).

Next, in S11, the recording unit 112 encrypts the information index acquired by the acquisition unit 111 and the information indicating the storage destination of the log data. For example, the recording unit 112 may encrypt the information indicating the information indexes and the storage destinations of the log data by using an encryption algorithm such as RSA encryption, data encryption standard (DES), triple DES, advanced encryption standard (AES), or Twofish.

Subsequently, in S12, the recording unit 112 records the information indexes encrypted by S11 and the information indicating the storage destinations of the log data in the storage unit 120. The recording unit 112 records the information index and the information indicating the storage destination of the log data corresponding to the information index in the storage unit 120 in association with each other. In addition, the recording unit 112 may convert the position at which the corresponding log data included in the information index is collected into a representation based on a bit string based on the space-filling curve from the latitude and longitude information and record it. Specifically, the position at which the corresponding log data included in the information index is collected may be represented by a bit string based on a Hilbert curve or a Z-order curve.

Next, a process of specifying a storage destination of the log data to be acquired by the server device 100 and acquiring the log data will be described. FIG. 3B illustrates a series of processes performed by the server device 100 for identifying a storage destination of log data to be acquired and acquiring the log data. The processing described in FIG. 3B may not be executed continuously with the processing in FIG. 3A as long as the processing in FIG. 3B is executed after the processing in FIG. 3A is executed.

First, in S20, the reception unit 113 receives, from an external device, an acquisition request to acquire first log data that is log data to be acquired. Here, the first log data acquisition request is information instructing the server device 100 to transmit the first log data to the external device.

Next, in S21, the extraction unit 114 identifies the information index of the log data matching the first log data. Specifically, the extraction unit 114 compares each parameter used in the condition for specifying the first log data with each parameter included in the plurality of information indexes recorded in the storage unit 120. Then, the extraction unit 114 extracts the information index of the log data matching the first log data. For example, the information index includes information indicating a position where the log data is collected. The information indicating the position at which the log data was collected is represented by a bit string based on a space-filling curve. A method in which the information indicating the position at which the log data is collected is represented by a bit string based on a space-filling curve will be described later.

Subsequently, in S22, the extraction unit 114 extracts the first storage that is the storage destination of the first log data. The extraction unit 114 refers to the information indicating the storage destination of the log data associated with the information indexes specified by S21, and extracts the storage destination as the first storage.

Next, in S23, the request unit 115 acquires the first log data from the first storages extracted by S22. The request unit 115 transmits information requesting that the first log data be transmitted to the server device 100 to the device having the first storage, communicates with the device, and acquires the first log data.

Subsequently, in S24, the request unit 115 transmits the first log data acquired by S23 to the external device. The request unit 115 communicates with the external device via the communication unit 130, and transmits the first log data to the external device.

Accordingly, the server device 100 can provide the log data collected by the vehicle 200 to the external device in response to a request, even if a large-capacity storage capacity is not held. Therefore, the server device 100 can reduce the storage capacity and cost required when responding to the data acquisition request.

### Representation of Location Information

Next, the bit string representation of the position information based on the space-filling curve will be described.

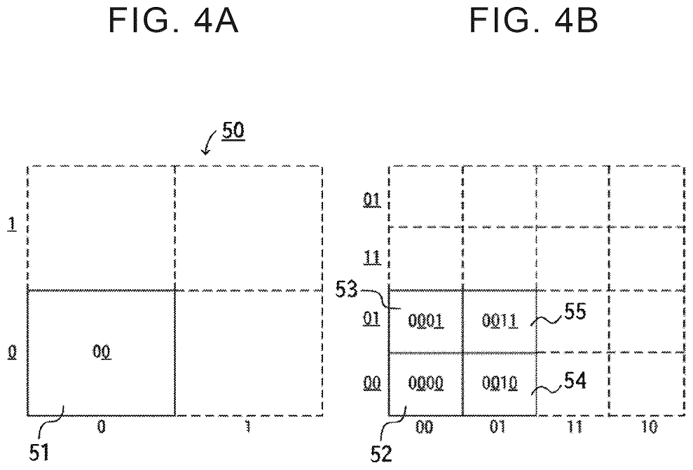

FIGS. 4A and 4B are diagrams for describing a bit string representation of position information based on a space-filling curve (in other words, a method of generating position code). The position code represents the position as a rectangle having a predetermined range. Specifically, a rectangular region is designated by a combination of these bits by defining a first bit string for specifying a position in the latitude direction (first direction) and a second bit string for specifying a position in the longitude direction (second direction).

The example of FIG. 4A is an example in which the entire region 50 is divided into two in the latitude-longitude direction, and a total of four regions are defined. Since the latitude direction and the longitude direction are divided into two, the bit string representing the position in the latitude direction and the longitude direction is a length of one bit. For example, the region 51 is represented by “00” and 2 bits by combining the bit “0” representing the position in the latitude direction and the bit “0” in the longitude direction.

The example of FIG. 4B is an example in which the entire region 50 is divided into four in the latitude-longitude direction, and a total of 16 regions are defined. Since the latitude direction and the longitude direction are divided into four, the bit string representing the position in the latitude direction and the longitude direction is a length of two bits. Here, in FIG. 4B, the division of FIG. 4A is subdivided, and therefore a bit string for specifying the latitude direction and the longitude direction is created by adding 1 bit to the bit string in FIG. 4A. The regions 52 to 55 in FIG. 4B are represented by bit strings in which bit strings representing the latitude direction and bit strings representing the longitude direction are alternately arranged. For example, the region 53 is expressed as “0001” by alternately arranging the bit string “00” for specifying the longitude direction and the bit string “01” for specifying the latitude direction. In FIGS. 4A and 4B, underlining is added to the bit string for specifying the latitude.

Since the position code is determined based on such a rule, the region (rectangle) represented by the position code has a size corresponding to the number of bits of the position code. Specifically, the smaller the number of bits, the wider the region, and the larger the number of bits, the narrower the region. In addition, each time the hierarchy of the division increases by one step, the region is ¼ and the position code is increased by 2 bits. The region of the upper layer (for example, the region 51) is a region equal to the sum of the regions of the lower layer (for example, the regions 52 to 55).

Here, although the two-dimensional position code has been described, the position and the region in the three-dimensional space can be represented on the basis of the three-dimensional space-filling curve obtained by adding the altitude. In the present disclosure, the three-dimensional position of UE may be represented in a position code format, or the three-dimensional position of UE may be represented in a combination of a two-dimensional position code format and an elevation.

In addition, in the position code of the region of the lower layer included in the region of the higher layer, the higher bit is equal to the position code of the region of the higher layer. For example, the upper two bits of each of the regions 52 to 55 are equal to the position code “00” of the region 51 of the upper layer including these regions. Therefore, according to such a code representation, it is possible to easily compare the inclusion relationships of the regions with each other by comparing bit strings, in other words, by using only a bit logic operation. It should be noted that confirmation of the inclusion relationship by the matching determination of the higher-order bits can be applied to the region comparison between arbitrary layers.

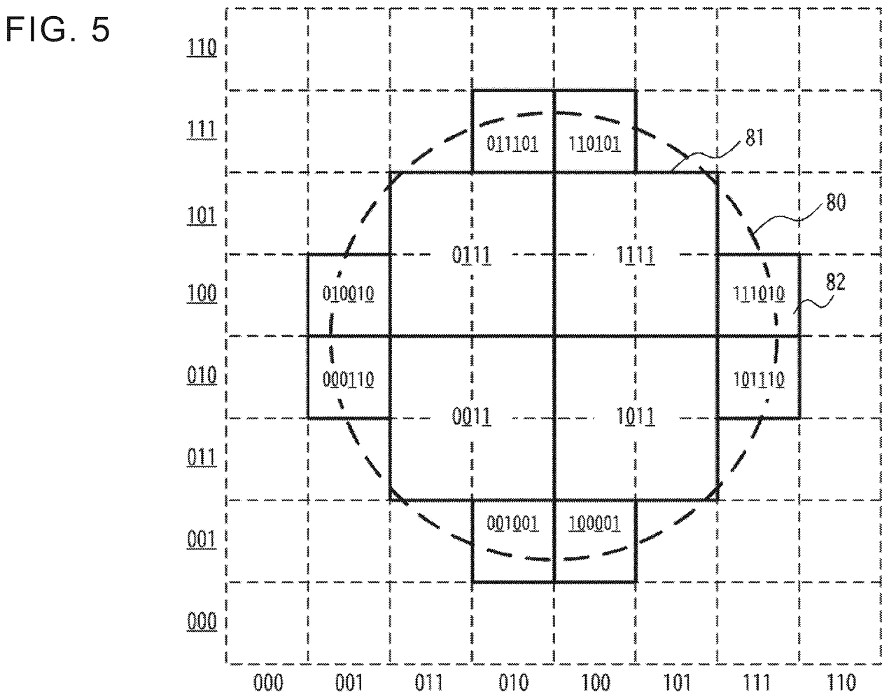

FIG. 5 is a diagram for describing an example in which a circular region 80 is represented in a position code format as one example of representing a position code of an arbitrarily shaped region. In this example, it is shown that the circular region 80 indicated by a broken line can be represented by a combination of four rectangular regions 81 represented by 4 bits and eight rectangular regions 82 represented by 6 bits. As described above, an arbitrarily shaped region can be represented by enumerating bit string representing a plurality of rectangular regions. It should be noted that the explanation of FIG. 5 is an outline, and the number of bit strings representing respective rectangular regions may be larger.

In order to determine the inclusion relationship between the region represented by the position code format specifying the first log data and the position code included in the information index, the inclusion relationship between each rectangular region constituting the region and the position code of the information index may be performed by comparing the upper bits, and it may be determined whether or not the position indicated by the position code of the information index is included in any rectangular region. Since this is a simple process of comparing bit strings (bit OR operation), it is possible to perform a quick determination process even if the number of rectangles constituting the region is large.

### Details of Operation of Server Device

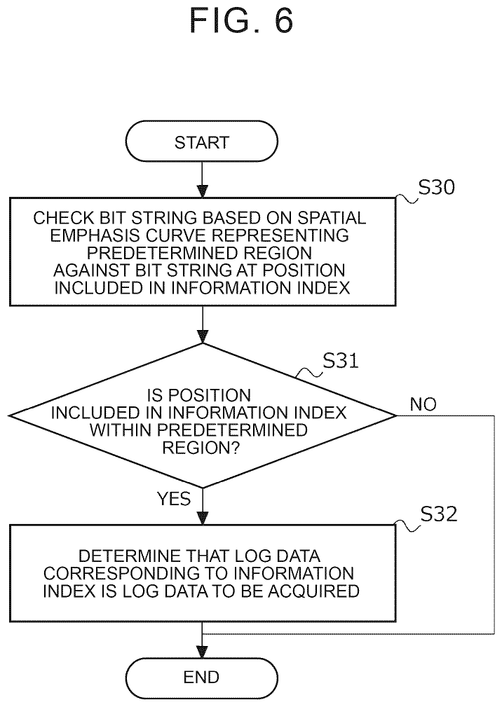

Next, a detailed description will be given of a process of acquiring the first log data performed by the control unit 110 of the server device 100. FIG. 6 is a flow chart of a process for identifying the first log data executed by the control unit 110 of the server device 100 according to the embodiment. When the server device 100 receives the acquisition request to acquire the first log data from the external device, it is necessary to identify the corresponding information index based on the position information specifying the first log data, and extract the storage destination of the first log data associated with the information index. FIG. 6 shows a process in which the server device 100 compares the position information specifying the first log data requested to be acquired from the external device with the position information included in the information index.

First, in a S30, the extraction unit 114 collates a bit string based on a space-filling curve representing a predetermined region for designating the first log data with a bit string of position information included in the information index. Here, it is assumed that the bit string of the position information included in the information index is also represented by a bit string based on the space-filling curve.

Next, in S31, the extraction unit 114 determines whether or not the position represented by the bit string of the position information included in the information index is included in the predetermined region. Specifically, the extraction unit 114 determines whether or not the bit string of the position information indicating the predetermined region for designating the first log data matches the bit string of the position information included in the information index. Here, “matching” includes not only strictly overlapping points, but also including the other being included in a region having a predetermined width. For example, consider a case where the region represented by the bit string of the position information indicating the predetermined region for designating the first log data is wider than the region represented by the bit string of the position information included in the information index. In this case, the extraction unit 114 may determine whether the high-order bit of the bit string of the position information included in the information index matches the bit string of the position information indicating the predetermined region for designating the first log data.

In this step, when the extraction unit 114 determines that the position represented by the bit string of the position information included in the information index is included in the predetermined region, an affirmative determination is made.

If an affirmative determination is made in this step, the process transitions to S32.

If a negative determination is made in this step, the process ends.

When the process transitions to S32, the extraction unit 114 determines that the log data corresponding to the information index is the first log data to be acquired.

As a result, the server device 100 manages the position information indicating the position where the log data is collected in the position code format, so that it is possible to easily extract the log data (typically, the first log data to be acquired) collected in a predetermined region. Therefore, the server device 100 can quickly provide the log data collected in the predetermined region to the external device.

As described above, in the present embodiment, the server device 100 records only the information index having a smaller data amount than the log data and the information indicating the storage destination of the log data in the storage unit 120 of the server device itself. The server device 100 does not record the log data itself in the storage unit 120 that it has. Then, the first storage, which is a storage destination of the specific log data, is specified on the basis of the information index recorded in the storage unit 120 included therein and the information indicating the storage destination of the log data, and the specific log data is acquired from the first storage. As a result, the server device 100 can acquire the log data requested to be acquired from the external device and provide the log data to the external device with a smaller storage capacity than when the log data itself is recorded in the storage unit 120 of the server device itself.

### Other Embodiments

The above-described embodiment is merely an example, and the present disclosure may be appropriately modified and implemented without departing from the scope thereof.

In the above-described embodiment, the server device 100 converts the position information indicating the position at which the log data is collected from the latitude and longitude information into the position code format, but the present disclosure is not limited thereto. The data collection unit 211 of the vehicle 200 may include the position information indicating the position at which the log data is collected in the log data by representing a bit string using a space-filling curve (for example, a Hilbert curve or the like).

In the above-described embodiment, the log data indicating the quality of communication is used as the acquisition target, but other data such as video data may be used as the acquisition target instead of the log data. In addition, the information-index may include a parameter related to a capability indicating the type of data that can be collected.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit, the control unit being configured to
store, in a storage unit, an information index related to log data collected by a vehicle and a storage destination of the log data associated with the information index,
refer to the storage unit to extract a first storage based on the information index, the first storage being a storage destination of first log data that is the log data to be acquired, and
request the first log data to a device including the first storage, wherein
the information index includes information indicating a position where the log data was collected, and
the information indicating the position where the log data was collected is represented by a bit string based on a space-filling curve.

2. The information processing device according to claim 1, wherein the information indicating the position where the log data was collected is represented by a bit string based on a Hilbert curve or a Z-order curve.

3. The information processing device according to claim 1, wherein the control unit is configured to
receive, from an external device, an acquisition request to acquire the first log data that meets a predetermined condition including designation of a predetermined region,
compare a bit string based on a space-filling curve representing the predetermined region with the bit string of the information indicating the position that is included in the information index,
when the position is within the predetermined region, acquire, as the first log data, the log data corresponding to the information index including the information indicating the position from the first storage, and
send the acquired first log data to the external device.

4. The information processing device according to claim 1, wherein the information index further includes at least one of the following pieces of information as a parameter included in a condition for designating the first log data: a travel speed of the vehicle, information indicating whether a vehicle safety event that is an event related to a traveling state of the vehicle has occurred, and a log level indicating a level of importance of a content represented by the log data.

5. The information processing device according to claim 1, wherein the control unit is configured to store, in the storage unit, a vehicle identification number as information indicating the storage destination of the log data, the vehicle identification number being a parameter included in a condition for designating the first log data.
